(19) United States
(12) Patent Application Publication
(10) Pub. No.: US 2024/0303288 A1
(43) Pub. Date: Sep. 12, 2024

(54) SIMILARITY MAPPING OF POST CONTENT IN HYPERSPACE

(71) Applicant: Meta Platforms, Inc., Menlo Park, CA (US)

(72) Inventors: Jun Mei, New York, NY (US); Siddarth Reddy Malreddy, Sunnyvale, CA (US); Piyush Maheshwari, San Francisco, CA (US); Yiqun Liu, San Francisco, CA (US); Kaushik Rangadurai, Sunnyvale, CA (US); Anthony Robert Bell, San Jose, CA (US); Fedor Borisyuk, Mountain View, CA (US); Xiaoyi Liu, San Bruno, CA (US)

(21) Appl. No.: 18/075,192

(22) Filed: Dec. 5, 2022

(51) Int. Cl. G06F 16/9536; G06Q 50/00

(52) U.S. Cl. CPC G06F 16/9536; G06Q 50/01

(57) ABSTRACT

Methods, systems, and storage media for determining the similarities of post content for mapping into a hyperspace. In an exemplary method, the disclosure comprises receiving a query at the processor. The method includes determining post data associated with the query. The post data comprises a plurality of posts provided to a social media platform by various users of the platform. The method includes determining, by the processor, a relationship between at least two posts of the plurality of posts. The method includes training, by the processor, a machine language model. The machine language model is based on the query and the relationship between the at least two posts. The method also generates a hyperspace based on the relationship between the at least two posts and the query.

### TECHNICAL FIELD

The present disclosure generally relates to defining similarities in social media posts, and more particularly to mapping similarities of the social media posts to a hyperspace platform.

### BACKGROUND

Theoretical search spaces can be useful optimizing future searches and predicting user interest in future content. This content can be photos, video, or text. Most theoretical search spaces for content are limited to one content only. To provide additional insight into optimizing searches and predicting content optimizing, cross-content searches can be considered. Determining the relative similarity between content can be useful, defining a basis for optimizing future searches and predicting user interest in future content.

### BRIEF SUMMARY

The subject disclosure provides for defining similarities of various forms of content including: text, video, and photo. The disclosure addresses the problem of establishing similarities between the post content associated with a query. The solution addresses the problem of predicting future engagement by a user on the platform by correlating the content of the posts. The similarities determined can be used to predict future engagement and generate suggested content that can be provided to the user of the platform.

One aspect of the present disclosure relates to a method for mapping similarities between content into a hyperspace. In an exemplary method, the disclosure comprises receiving a query at the processor. The method includes determining post data associated with the query. The post data comprises a plurality of posts provided to a social media platform by various users of the platform. The method includes determining, by the processor, a relationship between at least two posts of the plurality of posts. The method includes training, by the processor, a machine language model. The machine language model is based on the query and the relationship between the at least two posts. The method also can generate a hyperspace based on the relationship between the at least two posts and the query.

Another aspect of the present disclosure relates to a system configured for mapping similarities between content into a hyperspace. The system may include one or more hardware processors configured by machine-readable instructions. The processor(s) may be configured to receive a query at the processor. The processor can determine post data associated with the query. The post data comprises a plurality of posts provided to a social media platform by various users of the platform. The processor determines a relationship between at least two posts of the plurality of posts. The processor can train a machine language model. The machine language model is based on the query and the relationship between the at least two posts. The system can also generate a hyperspace based on the relationship between the at least two posts and the query.

Yet another aspect of the present disclosure relates to a non-transient computer-readable storage medium having instructions embodied thereon, the instructions being executable by one or more processors to perform a method for mapping similarities between content into a hyperspace. The method comprises receiving a query at the processor. The method includes determining post data associated with the query. The post data comprises a plurality of posts provided to a social media platform by various users of the platform. The method includes determining, by the processor, a relationship between at least two posts of the plurality of posts. The method includes training, by the processor, a machine language model. The machine language model is based on the query and the relationship between the at least two posts. The method also can generate a hyperspace based on the relationship between the at least two posts and the query.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary operating environment for client devices.

FIG. 2 illustrates a block diagram for multitasking in training the machine learning model.

FIG. 3 illustrates a system configured for mapping similarities between content into a hyperspace, in accordance with one or more implementations.

FIG. 4 is a block diagram illustrating an example computer system (e.g., representing both client and server) with which aspects of the subject technology can be implemented.

FIG. 5 illustrates an example flow diagram for determining the similarities of post content for mapping into a hyperspace, according to certain aspects of the disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The difference between the types of content increases the difficulty in determining similarities between the posts. The techniques discussed in the disclosure identifies a basis for comparison across the photo, video, and text posts associated with a query. The subject disclosure provides for systems and methods for determining similarities between the posts. Once a relative similarity can be determined by a post, a mapping of the relative hyperspace between the query and post content can be generated. The resultant mapping can be used to further train a model to predict user engagement on the platform and generate content of interest for a user. Further, the mapping can be used for post-text retrieval and ranking.

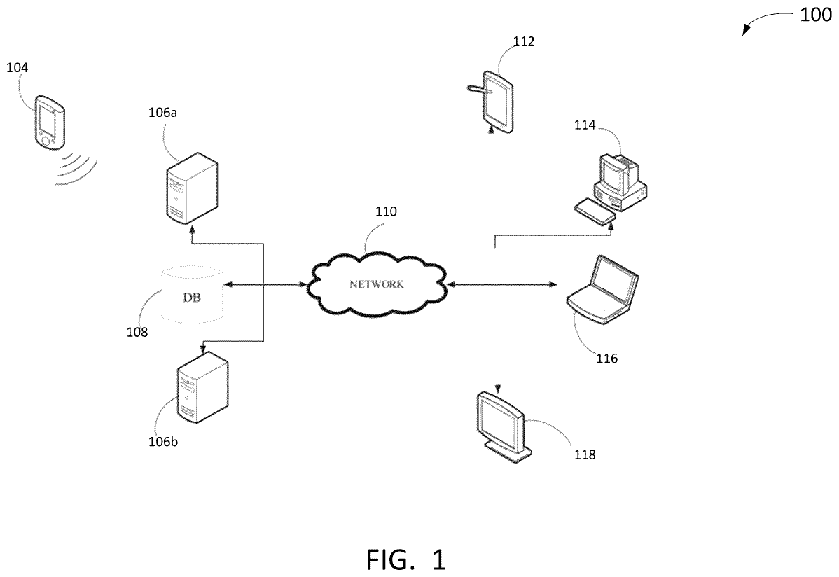

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices. The server computing devices 106a-106b may be configured to show (e.g., make encrypted content visible) content to one or more of the client computing devices for those client computing devices that presented a correct public key. As an example, the server computing devices 106a-106b can include a database (e.g., database 108) that tracks which users of the client computing devices have granted access to their encrypted content (e.g., encrypted by corresponding privately held private keys) to other client users.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations. The database 108 can store data indicative of keys or access granted by a given user to other users of the given user's encrypted content and/or shared social media content that can be subscribed to by other users. The database 108 may also be used to facilitate key rotation in a one to many encryption architecture by causing issue of new keys when a copy of a shared key becomes comprised, for example.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network. In some implementations, the server computing devices 106a-106b can be used as part of a social network such as implemented via the network 110. The social network can host content and protect access to the content, such as via the database 108, although the server computing devices 106a-106b of the social network do not have access to private keys and can be remote/separate from the application(s) that perform key generation and content encryption. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc.

Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea. The social networking system can enable a user to enter and display information related to the users' interests, age/date of birth, location (e.g., longitude/latitude, country, region, city, etc.), education information, life stage, relationship status, name, a model of devices typically used, languages identified as ones the user is familiar with, occupation, contact information, or other demographic or biographical information in the users' profile. Any such information can be represented, in various implementations, by a node or edge between nodes in the social graph.

The social networking system can enable a user to upload or create pictures, videos, documents, songs, or other content items, and can enable a user to create and schedule events. Content items can be represented, in various implementations, by a node or edge between nodes in the social graph. The social networking system can enable a user to perform uploads or create content items, interact with content items or other users, express an interest or opinion, or perform other actions. The social networking system can provide various means to interact with non-user objects within the social networking system. Actions can be represented, in various implementations, by a node or edge between nodes in the social graph. For example, a user can form or join groups, or become a fan of a page or entity within the social networking system. In addition, the user can create, download, view, upload, link to, tag, edit, or play a social networking system object. The user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, the user can use location detection functionality (such as a GPS receiver on a mobile device) to “check in” to a particular location, and an edge can connect the user's node with the location's node in the social graph.

The social networking system can provide a variety of communication channels to users. For example, the social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their avatar or true-to-life representation) with objects or other avatars in a virtual environment (e.g., in an artificial reality working environment), etc. In some embodiments, a user can post a status message to the user's profile indicating a current event, state of mind, thought, feeling, activity, or any other present-time relevant communication. The social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment where users can communicate and interact via avatars or other digital representations of themselves. Further, the first user can comment on the profile page of a second user or can comment on objects associated with the second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users, and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

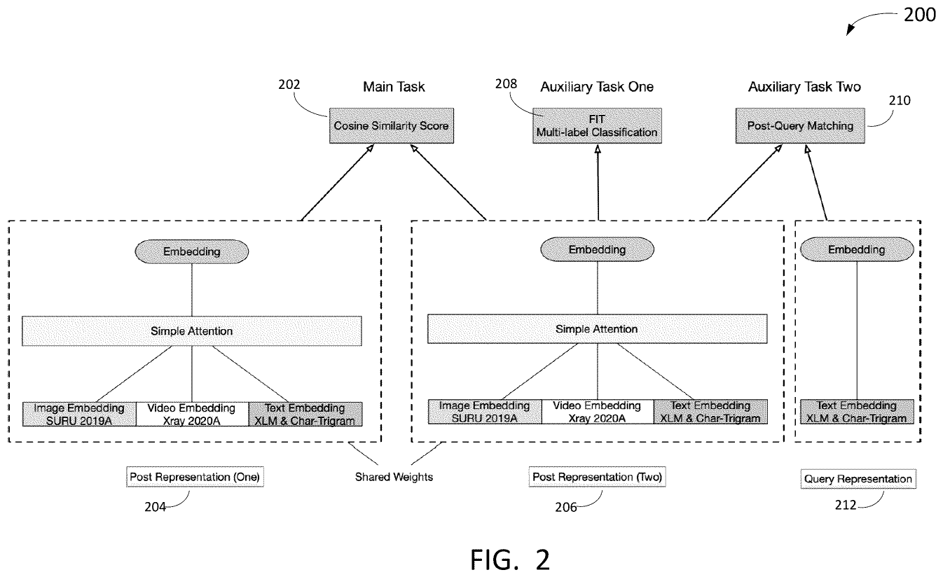

FIG. 2 illustrates an exemplary block diagram of the model 200. In training the model 200, the model can implement multimodal features to train the model using photos, videos, texts (posts) and group posts. The model 200 can implement additional features related to a post's community in the social media platform. Exemplary features such as an XLM encoder, SURU 2019a, and Xray 2020a can be used to embed text, photo and video into the model. The model can also implement a sparse feature to learn similar posts from the same/similar languages.

In a further aspect, the model can also implement modality masking by creating post fusion representations in the model training. Exemplary fusion representations can include: 1) using all features (both text and media); 2) only using text features (masking media features as zeros); and 3) only using media features (masking text features as zeros). All three whole-post embeddings can be used to calculate similarity scores. In further aspects, weights can be applied to the fusion representations to avoid overdominance of one of the fusion representations over the others. For example, weights can be used to balance a media-centric fusion representation with the text-centric because biasing of the overall score can occur to more text-centric posts than media-centric posts.

The model 200 can also implement auxiliary training such as multi-task learning. The auxiliary tasks under the multi-task learning can identify additional similarities between the content. A similarity score 202 can be generated between a first post 204 and a second post 206. Further, each post can be categorized under taxonomy classification 208, such as Facebook Interest Taxonomy FIT topics (e.g. fashion and style; food and drink; health and medical; home and garden; performing arts) The classification 208 is not limited to a single class. For example, a post about “seagulls” could be classified to be about both “birds” and “beach.” The model 200 can also include post-query matching 210 based on defining similarities between the search query 212 and each post (second post 206).

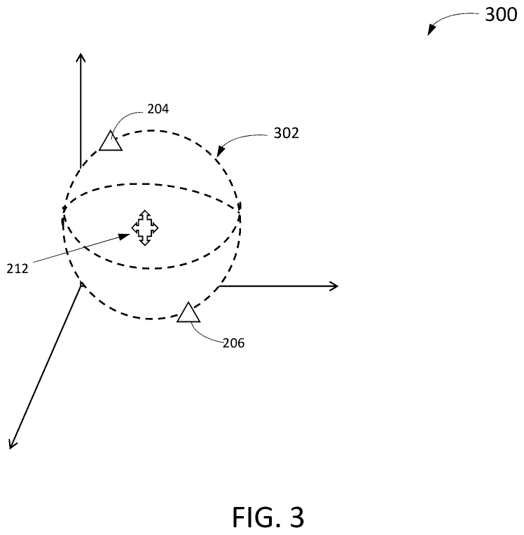

The similarity score 202, classification 204 and post-query matching can be used to map the relationships between the posts and into a hyperspace. The exemplary hyperspace 300 as depicted inn FIG. 3 represents a multidimensional mapping between the query 212 and each post. A mapping in the hyperspace 300 can also comprise a fuzzy match 302. Each coordinate (aka, “embedding”) in this hyperspace comprises a sequence of floating point numbers. The spherical representation of the fuzzy match 302 can represent a visual relationship of the similarities between the query and the associated posts. In a further aspect, the subject of the posts identified in the fuzzy match can be used to also determine a semantic relationship between the posts and a semantic relationship between the query 212 and posts 204, 206. The result of the modeling can also generate numerical values that can be used for ranking and engagement of the posts to each other and query. In particular, the numerical values are represented by the coordinates that comprise the hyperspace In a further aspect the rankings can be used to output, 1) post to post recommendations; 2) post recommendations based on a user's engaged posts; 3) group recommendations for a user on the social media platform; 4) hashtag recommendations based on the relationships between the posts and 5) event recommendations for the user.

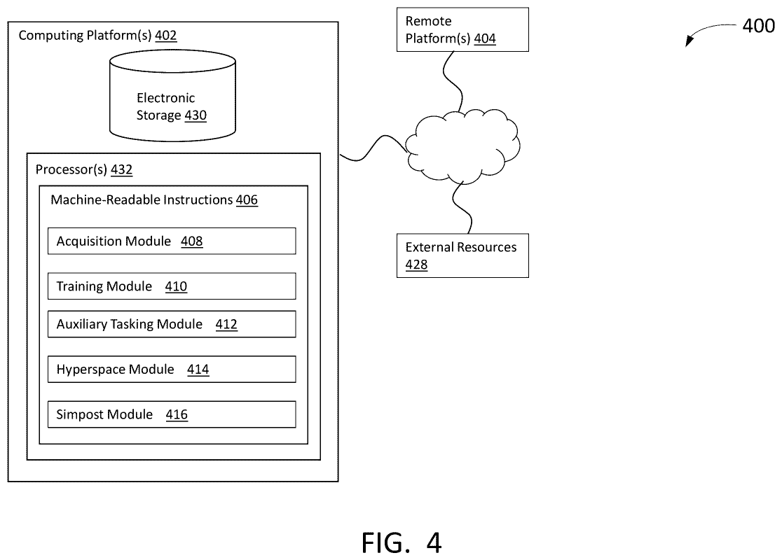

FIG. 4 illustrates a system 400 configured for providing ephemeral messages, according to certain aspects of the disclosure. In some implementations, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of request acquisition module 408, training module 410, auxiliary tasking module 412, hyperspace module 414, simpost module 416, and/or other instruction modules.

Acquisition module 408 may be configured to acquire post data associated with a query. The collected data can comprise photo, video, and text. The acquisition module 408 can collect clicked data accessed via the social media platform. The acquisition module 408 can also collect photo searches and video searches. The acquisition module 408 can also set timing thresholds. For example, a photo search can reach into a 90 day history and a video search can reach into a 30 day history. The collected data can also be used to help train the model.

Training module 410 may be configured to determine the similarities between post content and the associated query. The training model in the training module 410 can be rooted in the assumption that a user's click behaviors indicated the relevance between the search query and the clicked documents. The framework of the model can comprise a two-tower framework.

Auxiliary tasking module 412 may be configured in implementing multitasking. The multitasking can include auxiliary tasks of moving similar posts closer to an embedding space (multi-dimensional space). The auxiliary tasks can be used to increase the understanding of similarities between posts. One auxiliary task can include query to text (post) embedding. Another auxiliary task can include determining taxonomy classifications between content to clarify a manner in which the content query can be grouped.

Hyperspace module 414 can be configured to generate a representation of the embedded relationships between a query and associated posts determined by the acquisition module. The hyperspace module can further identify the scope of a fuzzy match between the content. The fuzzy match can be based off a semantic relation between the post data. For example, natural language feature applied to the string data of the posts or descriptive data from the metadata of the post.

Simpost module 416 may be configured to predict future engagement by the user based on the resultant relationships between the post and queries that were mapped into the hyperspace. Output by the simpost module can include: 1) post to post recommendations; 2) post recommendations based on a user's engaged posts; 3) group recommendations for a user on the social media platform; 4) hashtag recommendations based on the relationships between the posts and 5) event recommendations for the user.

In some implementations, computing platform(s) 402, remote platform(s) 404, and/or external resources 428 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 428 may be operatively linked via some other communication media.

A given remote platform 404 may include one or more processors configured to execute computer program modules. The computer program modules may be configured to enable an expert or user associated with the given remote platform 404 to interface with system 400 and/or external resources 428, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 428 may include sources of information outside of system 400, external entities participating with system 400, and/or other resources. In some implementations, some or all of the functionality attributed herein to external resources 428 may be provided by resources included in system 400.

Computing platform(s) 402 may include electronic storage 430, one or more processors 432, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 430 may comprise non-transitory storage media that electronically stores information. The electronic storage media of electronic storage 430 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 430 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 430 may include one or more virtual storage resources (e.g., cloud storage, a virtual private network, and/or other virtual storage resources). Electronic storage 430 may store software algorithms, information determined by processor(s) 432, information received from computing platform(s) 402, information received from remote platform(s) 404, and/or other information that enables computing platform(s) 402 to function as described herein.

Processor(s) 432 may be configured to provide information processing capabilities in computing platform(s) 402. As such, processor(s) 432 may include one or more of a digital processor, an analog processor, a digital circuit designed to process information, an analog circuit designed to process information, a state machine, and/or other mechanisms for electronically processing information. Although processor(s) 432 is shown in FIG. 3 as a single entity, this is for illustrative purposes only. In some implementations, processor(s) 432 may include a plurality of processing units. These processing units may be physically located within the same device, or processor(s) 432 may represent processing functionality of a plurality of devices operating in coordination. Processor(s) 432 may be configured to execute modules 408, 410, 412, 414, and/or 416, and/or other modules. Processor(s) 432 may be configured to execute modules 408, 410, 412, 414, and/or 416, and/or other modules by software; hardware; firmware; some combination of software, hardware, and/or firmware; and/or other mechanisms for configuring processing capabilities on processor(s) 432. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, and/or 416 are illustrated in FIG. 3 as being implemented within a single processing unit, in implementations in which processor(s) 432 includes multiple processing units, one or more of modules 408, 410, 412, 414, and/or 416 may be implemented remotely from the other modules. The description of the functionality provided by the different modules 408, 410, 412, 414, and/or 416 described below is for illustrative purposes, and is not intended to be limiting, as any of modules 408, 410, 412, 414, and/or 416 may provide more or less functionality than is described. For example, one or more of modules 408, 410, 412, 414, and/or 416 may be eliminated, and some or all of its functionality may be provided by other ones of modules 408, 410, 412, 414, and/or 416. As another example, processor(s) 432 may be configured to execute one or more additional modules that may perform some or all of the functionality attributed below to one of modules 408, 410, 412, 414, and/or 416.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

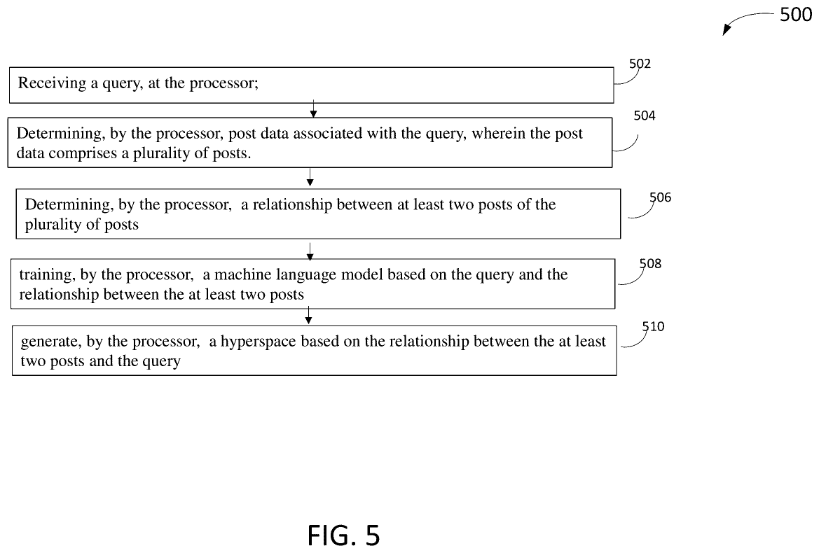

FIG. 5 illustrates an example flow diagram (e.g., process 500) for determining the similarities of post content for mapping into a hyperspace, according to certain aspects of the disclosure. For explanatory purposes, the example process 500 is described herein with reference to FIGS. 1-4. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to FIGS. 1-4.

At step 502, the process 500 may include receiving a query, at the processor. When the user is in the social media platform they may enter a text query into a search tool in the user interface of the social media platform. At step 504, the process 500 may include determining, by the processor, post data associated with the query, wherein the post data comprises a plurality of posts. In one aspect, the analysis of the post can be completed on a back-end server. The analysis to associated posts to the query can be processing while the user continues to interact with the user interface of the platform, running on the front-end.

At step 506, the process 500 can include determining, by the processor, a relationship between at least two posts of the plurality of posts. In a further aspect, relationship between two posts or a post and a query can be based on a historical analysis of the data. For example, clicked (selected) data from 1) photo searches over a period (e.g., 90 days); 2) video searches of a second period (e.g., 30 days), and 3) entered-text post pairs can be paired by joining on a normalized query. In a further aspect, determining the relationship comprises matching the text data of posts of the plurality of posts. The text data can the explicit string data of the post URL link. The text data can also be description data of the post's meta data. In yet a further aspect, noise in the data can be reduced establishing a threshold between the pairing. The pairings can be filtered by the number of clicks. For example, a query/post paring can be filtered from the data set if it is not clicked by at least two users. The filters can also be adjusted to increasing the minimum number of click for cross type content, such as post (text) to video, photo to video, and post to photo.

At step 508, the process 500 can train, by the processor, a machine language model based on the query and the relationship between the at least two posts. The model can apply multimodal features to evaluate similarities between text (post), video, and photos. The model can also implement multitasking by comparing post-to-query and determining a taxonomy category associated with the query or the plurality of posts. At step 510, the process can generate, by the processor, a hyperspace based on the relationship between the at least two posts and the query. In a further aspect, generating a hyperspace can comprise generating a fuzzy match between the query and the at least two posts. The fuzzy match can be a heuristic that uses the resultant similarity relationship from the model. The fuzzy match can define semantic meaning to the relationship between the query and the plurality of posts. The relationships between the posts and queries in the hyperspace can also be used to predict a hashtag for the relationship between the posts.

According to an aspect, the query is received on a social media platform.

According to an aspect, the metadata associated with each post is a URL link.

According to an aspect, the URL link comprises string data that names the URL link and descriptive text of the URL link.

According to an aspect, determining the plurality of posts can comprise collecting a plurality of posts generated in response to the query.

According to an aspect, the post data comprises photo content or video content uploaded to a social media platform.

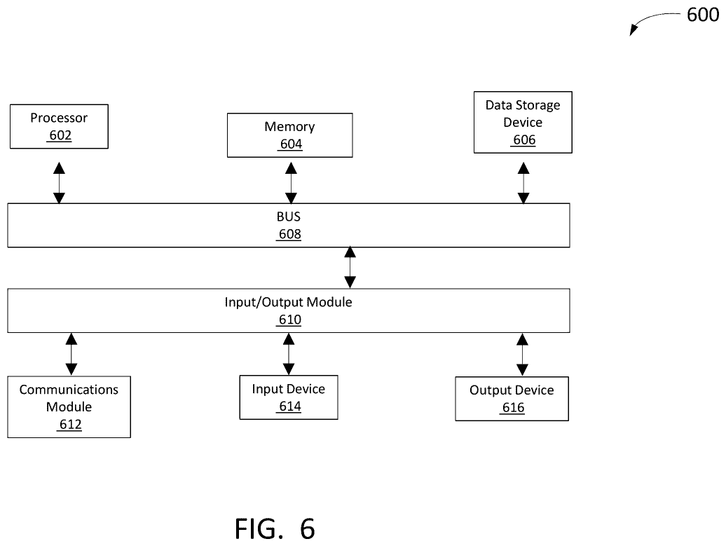

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described gaming systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads game data and provides a game, information may be read from the game data and stored in a memory device, such as the memory 604. Additionally, data from the memory 604 servers accessed via a network the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include.” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for determining similarities of post content for mapping into a hyperspace, the method comprising:
receiving a query, at a processor;
determining, by the processor, post data associated with the query, wherein the post data comprises a plurality of posts;
determining, by the processor, a relationship between at least two posts of the plurality of posts;
training, by the processor, a machine language model based on the query and the relationship between the at least two posts; and
generating, by the processor, a hyperspace based on the relationship between the at least two posts and the query.

2. The method of claim 1, further comprising filtering a post from the plurality of posts based on a number of clicks.

3. The method of claim 1, further comprising generating a fuzzy match between the query and the at least two posts, wherein the fuzzy match defines a semantic meaning to the relationship between the query and the plurality of posts.

4. The method of claim 1, wherein the method further comprises determining a hashtag based on the query and the relationship between the at least two posts.

5. The method of claim 1, wherein the method further comprises determining a taxonomy category associated with the query or the plurality of posts.

6. The method of claim 1, wherein determining the relationship comprises matching text data associated with a post of the plurality of posts and text data associated with the query.

7. The method of claim 1, wherein the hyperspace comprises a plurality of coordinates, wherein the plurality of coordinates are determined from the relationship between the at least two posts and the query.

8. A system configured determining similarities of post content for mapping into a hyperspace, the system comprising:
one or more hardware processors configured by machine-readable instructions to:
receive a query;
determine post data associated with the query, wherein the post data comprises a plurality of posts;
determine a relationship between at least two posts of the plurality of posts;
train a machine language model based on the query and the relationship between the at least two posts; and
generate a hyperspace based on the relationship between the at least two posts and the query.

9. The system of claim 8, wherein the one or more hardware processors are further configured by machine-readable instructions to filter a post from the plurality of posts based on a number of clicks.

10. The system of claim 8, wherein the one or more hardware processors are further configured by machine-readable instructions to generate a fuzzy match between the query and the at least two posts, wherein the fuzzy match defines a semantic meaning to the relationship between the query and the plurality of posts.

11. The system of claim 8, wherein the one or more hardware processors are further configured by machine-readable instructions to determine a hashtag based on the query and the relationship between the at least two posts.

12. The system of claim 8, wherein the one or more hardware processors are further configured by machine-readable instructions to determine a taxonomy category associated with the query or the plurality of posts.

13. The system of claim 8, wherein the one or more hardware processors are further configured by machine-readable instructions to match text data associated with a post of the plurality of posts and text data associated with the query.

14. The system of claim 8, wherein the one or more hardware processors are configured by machine-readable instructions to determine the relationship comprises matching text data between posts of the plurality of posts.

15. A non-transient computer-readable storage medium having instructions embodied thereon, the instructions being executable by one or more processors to perform a method for determining similarities of post content for mapping into a hyperspace, the method comprising:
receiving a query, at the processor;
determining, by the processor, post data associated with the query, wherein the post data comprises a plurality of posts;
determining, by the processor, a relationship between at least two posts of the plurality of posts;
training, by the processor, a machine language model based on the query and the relationship between the at least two posts; and
generating, by the processor, a hyperspace based on the relationship between the at least two posts and the query.

16. The non-transient computer-readable storage medium of claim 15, the method further comprising filtering a post from the plurality of posts based on a number of clicks.

17. The non-transient computer-readable storage medium of claim 15, the method further comprising generating a fuzzy match between the query and the at least two posts, wherein the fuzzy match defines a semantic meaning to the relationship between the query and the plurality of posts.

18. The non-transient computer-readable storage medium of claim 15, wherein the method further comprises determining a hashtag based on the query and the relationship between the at least two posts.

19. The non-transient computer-readable storage medium of claim 15, wherein the method further comprises determining a taxonomy category associated with the query or the plurality of posts.

20. The non-transient computer-readable storage medium of claim 15, wherein determining the relationship comprises matching text data associated with a post of the plurality of posts and text data associated with the query.
